(19) United States
(12) Patent Application Publication
(10) Pub. No.: US 2022/0074520 A1
(43) Pub. Date: Mar. 10, 2022

(54) PLASTIC OPERATING GRIP APPARATUS

(71) Applicants: Victor Postel, Wylie, TX (US); Sean Quigley, McKinney, TX (US)

(72) Inventors: Victor Postel, Wylie, TX (US); Sean Quigley, McKinney, TX (US)

(21) Appl. No.: 17/017,010

(22) Filed: Sep. 10, 2020

(51) Int. Cl. F16L 3/08; F16L 3/14

(52) U.S. Cl. CPC F16L 3/085; F16L 3/14

(57) ABSTRACT

An apparatus for securing a portion of a vertical line feeder in a fixed position relative to a horizontal water return pipe having a resilient plastic body having a curved lower portion dimensioned to be received by the curvature of the horizontal water return pipe and, proximate the upper portion of the body, a protrusion dimensioned to be received in an aperture located at the base of a vertical line feeder. The body is generally a triangular shaped cylinder with an upper curved vertex, a first lower curved vertex and a second lower curved vertex. A channel is formed through the body for receiving a hose clamp. The hose clamp secures the resilient body to the horizontal water return pipe.

### CROSS REFERENCE TO RELATED APPLICATION

Not applicable

### TECHNICAL FIELD

The present invention relates to swimming pool chlorinating systems.

### BACKGROUND OF THE INVENTION

Owners and maintainers of swimming pools desire efficient systems to sanitize their pools or spas. Manufacturers of pool sanitizing systems have developed feeders that receive tablets that reduce manual handling of chemicals. Typically, these feeders are vertical tubes configured to receive various sized trichlor (chlorine) or bromine slow-dissolving tablets. Standard tablet sizes are 1 inch and 3 inch in diameter. This makes pool and spa sanitizing efficient and automatic. These feeders are typically installed on the pressure side of the pump, downstream of the filter and heater. One type of feeder is an in-line feeder that includes an external fine-control valve to adjust the feed rate to meet specific pool or spa requirements. A feeder designed for permanent installation in the return line of the sanitation systems dispenses sanitizer directly into the pool or spa, downstream of all equipment. One disadvantage of sanitizing systems having an in-line feeder is that over time the lid at the top of the vertical line feeder becomes so tight that when removing the lid it will cause the entire body of the vertical line feeder to rotate in the same direction, causing a set screw that is purportedly designed to hold the device in place to damage the PVC plumbing. Thereafter, the vertical line feeder will constantly turn when trying to remove the lid. What is desired is an apparatus that is configured to couple to the horizontal water return pipe either immediately upstream of the vertical line feeder or downstream of the vertical line feeder.

### SUMMARY OF THE INVENTION

The present invention is an apparatus for securing a portion of a vertical line feeder in a fixed position relative to a horizontal water return pipe. The invention is a body having a curved lower portion dimensioned to be received by the curvature of the horizontal water return pipe and is secured to the horizontal water return pipe using a hose clamp or similar fastening mechanism. The body has, at an upper portion thereof, a protrusion dimensioned to be received in an aperture located at the base of a vertical line feeder. As one skilled in the art will note, the invention is adaptable for securing any vertical pipe, such as a PVC pipe, to any horizontal pipe, also such as a PVC pipe.

To those skilled in the art to which this invention relates, many changes in construction and widely differing embodiments and applications of the invention will suggest themselves without departing from the scope of the invention as defined herein. The disclosures and the descriptions herein are purely illustrative and are not intended to be in any sense limiting.

### BRIEF DESCRIPTION OF THE DRAWINGS

For a better understanding of the present invention including the features, advantages and embodiments, reference is made to the following detailed description along with accompanying Figures wherein:

FIG. 1 is an illustration of a vertical line feeder (prior art);

FIG. 2 is a back view of the body of the invention;

FIG. 3 is a side view of the body of the invention;

FIG. 4 is a top view of the body of the invention;

FIG. 5 is a front view of the body of the invention;

FIG. 6 is a perspective view of the invention being loosely coupled using a hose clamp to a horizontal water return pipe prior to being mated immediately upstream to a vertical line feeder (front side installation);

FIG. 7 is a perspective view of the invention tightly coupled to a horizontal water return pipe using a hose clamp and mated immediately upstream to a vertical line feeder (front side installation);

FIG. 8 illustrates the knock-out removal for coupling the invention to a horizontal water return pipe using a hose clamp and mated immediately downstream of the vertical line feeder (back side installation); and

FIG. 9 illustrates the coupling of the invention to a horizontal water return pipe using a hose clamp and mated immediately downstream of the vertical line feeder (back side installation).

### DETAILED DESCRIPTION OF A PREFERRED EMBODIMENT

While the making and using of the disclosed embodiments of the present invention is discussed in detail below, it should be appreciated that the present invention provides many applicable inventive concepts which can be embodied in a wide variety of specific contexts. Some features of the preferred embodiments shown and discussed may be simplified or exaggerated for illustrating the principles of the invention.

The present invention is an apparatus for securing a portion of a vertical line feeder in a fixed position relative to a horizontal water return pipe. The invention is a body having a curved lower portion dimensioned to be received by the curvature of the horizontal water return pipe, the invention being secured to the horizontal water return pipe using a hose clamp or similar fastening mechanism. The body has at an upper portion thereof, a protrusion dimensioned to be received in an aperture located at the base of a vertical line feeder. As one skilled in the art will note, the invention is adaptable for securing any vertical pipe, such as a PVC pipe, to any horizontal water return pipe, also such as a PVC pipe. One object of the invention is to permit the loosening of a cap on a vertical pipe, such as a vertical line feeder, without turning, and possibly damaging, coupling components at the lower portion of the vertical pipe where it is coupled to the horizontal water return pipe. This often occurs when removing the lid of a chlorine line feeder to add chemical tablets to the sanitizing system.

The invention is a manifold shaped body made of a resilient material, including but not limited to molded plastic, the body generally being a cross section of a triangular shaped cylinder or trihedral with an upper curved vertex, a first lower curved vertex and a second lower curved vertex, a first side wall, or acclivity, extending from a first lower curved vertex to the upper curved vertex, a second side wall, or acclivity, extending from a second lower curved vertex to the upper curved vertex, and an incurvate bottom wall between the first lower curved vertex and the second lower curved vertex. The incurvate bottom wall is dimensioned to generally fix the shape of a horizontal water return pipe. A longitudinal slot or channel 302 is formed through the body from the first side wall to the second side wall, configured to receive a hose clamp. In an embodiment, the channel is ½ inches across and can receive a hose clamp of 2 inches to 3 inches in diameter. The body has a front wall and a back wall. The front wall is substantially planar, having a triangular shape, and protruding orthogonally from said planar surface is a solid cylinder or prolate proximate the upper curved vertex and dimensioned to be mated in an aperture located at the base of a vertical line feeder. The back wall is substantially planar or can be sculpted or dimensioned as a dihedral.

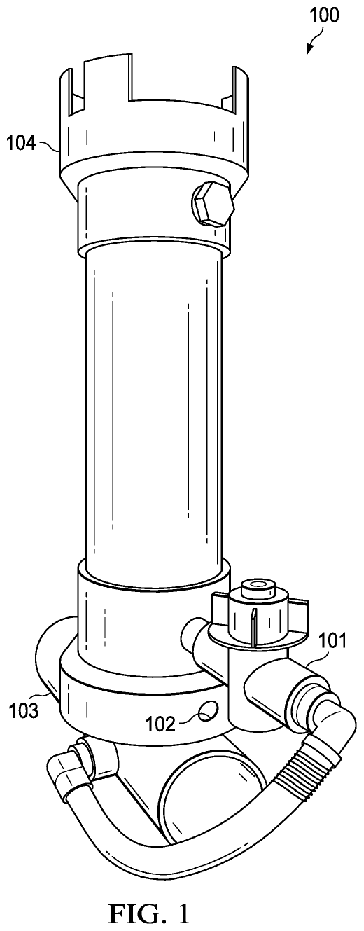

FIG. 1 is an illustration of a conventional vertical line feeder 100. Such vertical line feeder 100 has an external fine-control valve 101 to adjust the feed rate, a vertical line feeder aperture 102 at the base thereof, a coupling 103 for a horizontal water return pipe and a lid 104 at the top thereof that is coupled to the vertical line feeder using an internal thread within the interior wall of the lid 104 and the external threads on the top portion of the vertical line feeder 100. Lid 104 is rotated for removal so that chemical tablets can be inserted into the vertical line feeder 100.

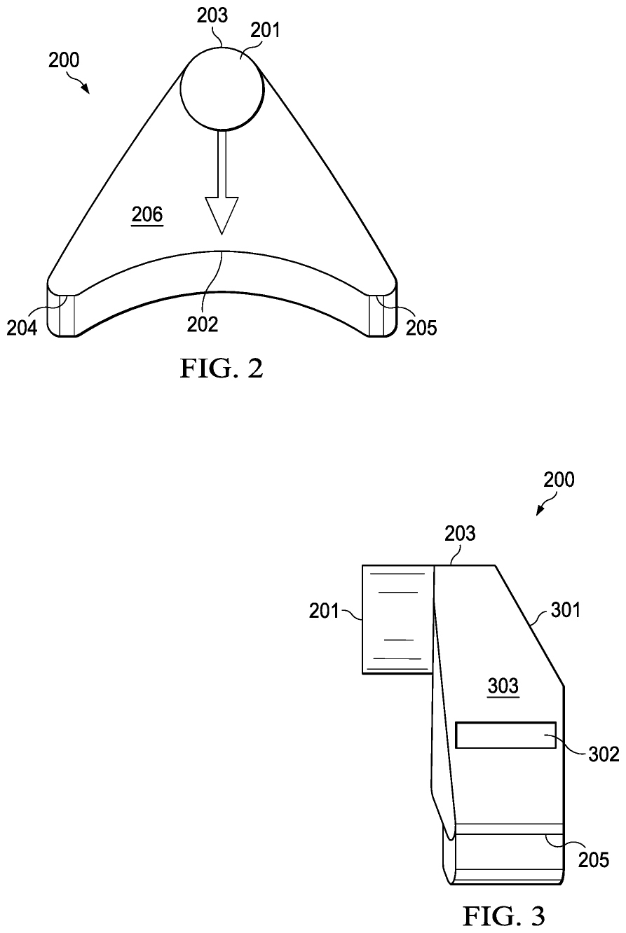

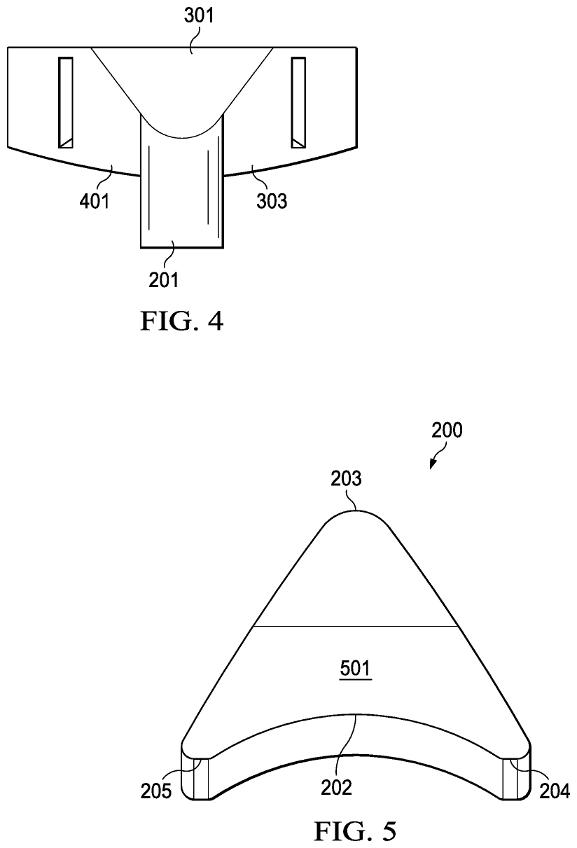

FIG. 2 is a back view of the body 200 of the invention. The body 200 is made of a resilient material, including but not limited to molded plastic, the body 200 generally being a cross section of a triangular shaped cylinder or trihedral with an upper curved vertex 203, a first lower curved vertex 204 and a second lower curved vertex 205. A first side wall 401 (seen in FIG. 4) is opposite second side wall 303 or acclivity and extends from a first lower curved vertex 204 to the upper curved vertex 203.

Referring to FIG. 2, a second side wall 303, or acclivity, extends from a second lower curved vertex 205 to the upper curved vertex 203, and an incurvate bottom wall 202 as seen in FIG. 2 between the first lower curved vertex 204 and the second lower curved vertex 205. The incurvate bottom wall 202 is dimensioned generally with concavity to correspond to the convex shape of a horizontal water return pipe on which it rests.

Referring to FIG. 3, a slot or channel 302 is formed generally longitudinally through the body 202 from the first side wall 401 to the second side wall 303, configured to receive a hose clamp 601 (seen in FIG. 6). In an embodiment, the slot or channel 302 is ½ inches across and can receive a hose clamp 601 of 2 inches to 3 inches in diameter.

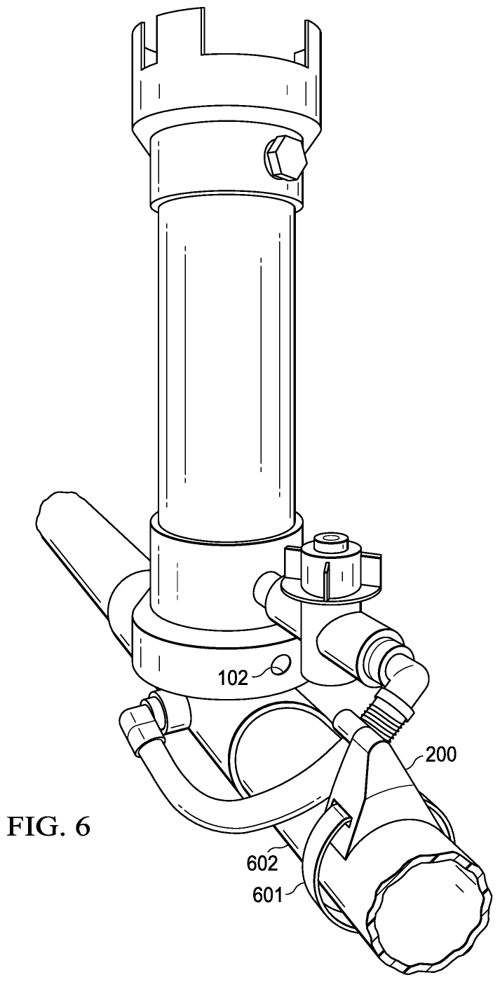

Referring back to FIG. 2 and to FIG. 5, body 200 has a front wall 206 and a back wall 501. Front wall 206 is substantially planar, having a triangular shape. Protruding orthogonally from said planar surface is a solid cylinder 201 or prolate proximate the upper curved vertex 203 and dimensioned to be mated in an aperture 102 located at the base of a vertical line feeder 100. back wall 501 is substantially planar or can be sculpted or dimensioned as a dihedral.

FIG. 3 is a side view of the body 200 of the invention showing second side wall 303, slot or channel 302, second lower curved vertex 205, solid cylinder 201 or prolate proximate the upper curved vertex 203 and dimensioned to be mated in an aperture 102 located at the base of a vertical line feeder 100.

FIG. 4 is a top view of the body 200 of the invention showing first side wall 401 to the second side wall 303 and solid cylinder 201 or prolate proximate the upper curved vertex 203.

FIG. 5 is a front view of the body 200 of the invention, the body 200 generally being a cross section of a triangular shaped cylinder or trihedral with an upper curved vertex 203, a first lower curved vertex 204 and a second lower curved vertex 205 and incurvate bottom wall 202.

FIG. 6 is a perspective view of the invention being loosely coupled using a hose clamp 601 to a horizontal water return pipe 602 prior to being mated immediately upstream to a vertical line feeder 100 in the front side installation.

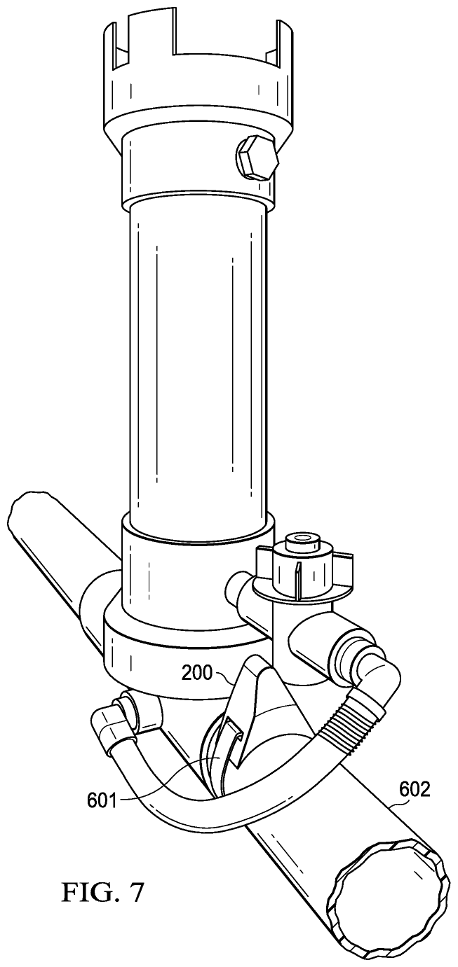

FIG. 7 is a perspective view of the invention tightly coupled to a horizontal water return pipe 602 using hose clamp 601 and mated immediately upstream to a vertical line feeder 100 in the front side installation.

The invention is configured to be installed in one of two methods. In the front side install, the invention is positioned upstream of the vertical line feeder 101 on the horizontal water return pipe 602, the solid cylinder or prolate 201 proximate the upper curved vertex 203 is inserted into vertical line feeder aperture 102. Hose clamp 601 previously or contemporaneously inserted through longitudinal slot or channel 302, is tightened to securely couple the 602 to vertical line feeder 101.

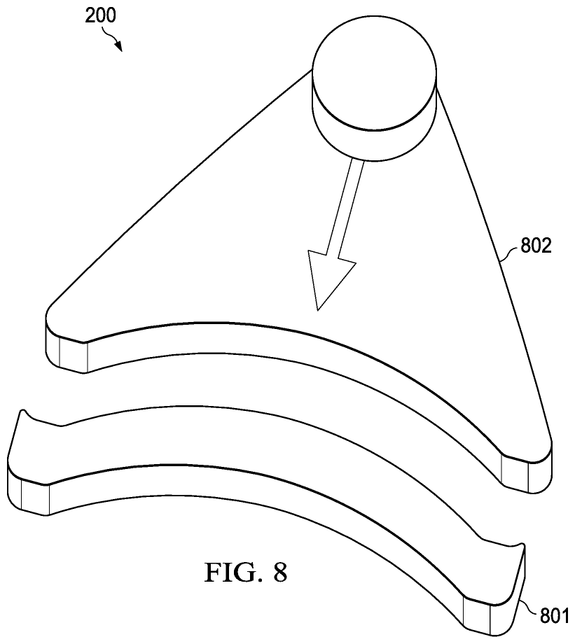

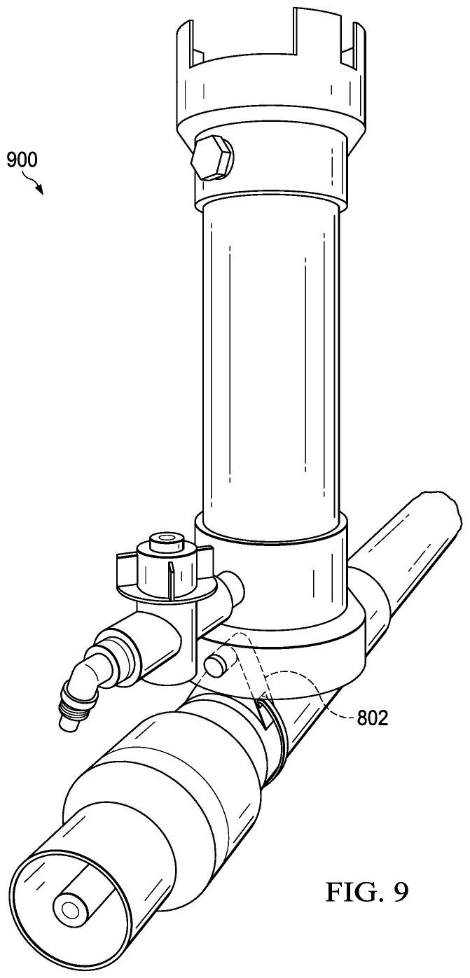

Alternatively, the invention can be installed using a back-side method. Referring to the back-side installation 900 of FIG. 9, the upper portion 802 of the invention is shown coupled to a horizontal water return pipe using a hose clamp and mated immediately downstream of the vertical line feeder (back side installation). In this method, the lower portion 801 of body 200 is removed using a flathead screwdriver at a location indicated by a “Knockout Arrow” as seen in FIG. 8. By removing lower portion 801, the upper portion 802 of the invention will be dimensioned to be received by an aperture located on the vertical line feeder 101 on a portion of a horizontal water return pipe downstream from the vertical line feeder.

The embodiments shown and described above are only exemplary. Even though numerous characteristics and advantages of the present invention have been set forth in the foregoing description, the disclosure is illustrative only and changes may be made within the principles of the invention to the full extent indicated by the broad general meaning of the terms used herein. Various alterations, modifications and substitutions can be made to the disclosed invention and the system that implements the present invention without departing in any way from the spirit and scope of the invention.

What we claim is:

1. An apparatus for securing a portion of a vertical line feeder in a fixed position relative to a horizontal water return pipe, comprising:
a resilient plastic body having a curved lower portion dimensioned to be received by the curvature of the horizontal water return pipe and, proximate the upper portion of the body, a protrusion dimensioned to be received in an aperture located at the base of a vertical line feeder.

2. The apparatus of claim 1, wherein the body is generally a triangular shaped cylinder with an upper curved vertex, a first lower curved vertex and a second lower curved vertex.

3. The apparatus of claim 2, further comprising a channel formed through the body for receiving a hose clamp.

4. The apparatus of claim 3, in combination with a hose clamp.

5. The apparatus of claim 3, wherein the body is molded from plastic.

6. The apparatus of claim 1, wherein the body is trihedral with an upper curved vertex, a first lower curved vertex and a second lower curved vertex.

7. The apparatus of claim 6, further comprising a channel formed through the body for receiving a hose clamp.

8. The apparatus of claim 7, in combination with a hose clamp.

9. The apparatus of claim 6, wherein the body is molded from plastic.

10. An apparatus for securing a vertical line feeder to a horizontal water return pipe, comprising:
a manifold shaped body made of a resilient material, further comprising:
a triangular shaped cylindrical cross section;
an upper curved vertex;
a first lower curved vertex;
a second lower curved vertex;
a first side wall, or acclivity, extending from a first lower curved vertex to the upper curved vertex;
a second side wall, or acclivity, extending from a second lower curved vertex to the upper curved vertex;
an incurvate bottom wall between the first lower curved vertex and the second lower curved vertex;
a slot or channel formed through the body from the first side wall to the second side wall;
a front wall having a generally triangular shape and being orthogonal to the first side wall and second side wall, wherein the front wall is substantially planar;
a back wall having a generally triangular shape and being orthogonal to the first side wall and second side wall; and
a solid cylinder or prolate proximate the upper curved vertex protruding orthogonally from the front wall and being dimensioned to be mated in an aperture located at the base of a vertical line feeder.

11. The apparatus of claim 10, further comprising a hose clamp being positioned within the slot or channel.

12. The apparatus of claim 10, in combination with a hose clamp.

13. The apparatus of claim 10, wherein the incurvate bottom wall is dimensioned to generally fix the shape of a horizontal water return pipe.

14. The apparatus of claim 10, wherein the back wall is substantially planar.

15. The apparatus of claim 10, wherein the back wall is dimensioned as a dihedral.

16. The apparatus of claim 10, wherein the body has an upper portion and a lower portion, the lower portion adapted to be removed from the upper portion of the body to reduce the height of the body.

17. The apparatus of claim 10, in combination with a vertical line feeder.

18. A method of securing a portion of a vertical line feeder in a fixed position relative to a horizontal return water pipe, comprising the steps of:
positioning a resilient plastic body having a curved lower portion dimensioned to be received by the curvature of the horizontal water pipe return on a horizontal water pipe return;
inserting a protrusion located proximate the upper portion of the body into an aperture located at the base of a vertical line feeder;
positioning a hose clamp through a slot through the resilient plastic body; and
tightening the hose clamp to the horizontal water pipe return.

19. The method of claim 18, wherein the resilient plastic body is generally a triangular shaped cylinder with an upper curved vertex, a first lower curved vertex and a second lower curved vertex.

20. The method of claim 18, wherein the resilient plastic body is positioned either upstream of the vertical line feeder or downstream of the vertical line feeder.
